(19) United States
(12) Patent Application Publication
(10) Pub. No.: US 2025/0366456 A1
(43) Pub. Date: Dec. 4, 2025

(54) Fishing Rod-Holding Device

(71) Applicant: Matthew Rawls, Tallahassee, FL (US)

(72) Inventor: Matthew Rawls, Tallahassee, FL (US)

(21) Appl. No.: 19/010,417

(22) Filed: Jan. 6, 2025

Related U.S. Application Data
(60) Provisional application No. 63/655,615, filed on Jun. 4, 2024.

(51) Int. Cl. A01K 97/10

(52) U.S. Cl. CPC A01K 97/10

(57) ABSTRACT

A fishing rod-holding device is provided comprised of a free-standing fishing rod holder device comprising a frame structure with at least one leg and multiple utility areas for fishing accessories. The frame, made from durable materials such as wood, metal, or UV-resistant PVC, incorporates a pointed-leg design for secure ground insertion, enhancing its stability. The leg can either be fixed or telescopic with locking mechanisms, allowing adjustable height configurations. Attached to the frame is a rod receiving area, typically a tubular structure, which holds the fishing rod handle, enabling hands-free fishing. This rod receiving area includes a pivot point allowing multi-directional angle adjustments using mechanisms like ball-and-socket or ratcheting joints for precise positioning. Additional features include a cup and bait receiving area with adjustable fasteners, designed to securely hold containers, making the device versatile and functional for fishing activities.

### CROSS-REFERENCE TO RELATED APPLICATION

The present application claims priority to, and the benefit of, U.S. Provisional Application No. 63/655,615, which was filed on Jun. 4, 2024, and is incorporated herein by reference in its entirety.

### FIELD OF THE INVENTION

The present invention relates generally to the field of fishing rods. More specifically, the present invention relates to a fishing rod-holding device that can simultaneously hold a plurality of fishing rods and also fishing-related supplies when bank fishing or boating. Accordingly, the present disclosure makes specific reference thereto. Nonetheless, it is to be appreciated that aspects of the present invention are also equally applicable to other like applications, devices, and methods of manufacture.

### BACKGROUND

Anglers who enjoy the thrill of using multiple fishing rods simultaneously often face significant challenges managing their equipment effectively. Holding onto several rods at once can become difficult, especially in high-action moments when a fish bites. The lack of a secure grip or stable position for each rod increases the risk of losing valuable catches to aggressive strikes. Balancing these rods while keeping everything in reach often turns into a frustrating juggling act, requiring the angler to constantly switch focus between rods, adjust lines, and tend to tangles, costing both time and missed opportunities.

Additionally, the need to move between fishing rods and tackle boxes can further add to the inconvenience. This constant back-and-forth not only disrupts the angler's rhythm but also leads to missed strikes and lost fish, detracting from the overall experience. The difficulties don't end there-transporting multiple rods from a vehicle or home to the fishing spot can be equally cumbersome. Without an organized carrying solution, the task of moving fishing gear is awkward and time-consuming, often requiring multiple trips. This leads to unnecessary fatigue and risks damage to the rods or reels along the way.

Moreover, anglers often struggle to find convenient places to set down bait containers, drinks, and other essential items while fishing. Without a designated area to store these items, they are prone to getting knocked over or spilled, creating a mess that can disrupt the fishing environment and lead to wasted bait or lost refreshments. This lack of organized storage adds to the frustration, as anglers end up wasting time cleaning up or retrieving supplies that were accidentally knocked over, further diminishing the enjoyment of the fishing experience. The fishing rod-holding device can be used on land or sea.

Therefore, there exists a long-felt need in the art for a device for holding multiple fishing rods. There also exists a long-felt need in the art for a fishing rod-holding device that can hold multiple fishing rods simultaneously. Further, there exists a long-felt need in the art for a fishing rod-holding device that can hold multiple fishing rods simultaneously wherein the device can also secure a bait container. In addition, there exists a long-felt need in the art for a fishing rod-holding device that can hold multiple fishing rods simultaneously wherein the device can also secure a drink.

The subject matter disclosed and claimed herein, in one embodiment thereof, comprises a fishing rod-holding device. The device is comprised of a free-standing fishing rod holder device comprising a frame structure with at least one leg and multiple utility areas for fishing accessories. The frame, made from durable materials such as wood, metal, or UV-resistant PVC, incorporates a pointed-leg design for secure ground insertion, enhancing its stability. The leg can either be fixed or telescopic with locking mechanisms, allowing adjustable height configurations. Attached to the frame is a rod receiving area, typically a tubular structure, which holds the fishing rod handle, enabling hands-free fishing. This rod receiving area includes a pivot point allowing multi-directional angle adjustments using mechanisms like ball-and-socket or ratcheting joints for precise positioning. Additional features include a cup and bait receiving area with adjustable fasteners, designed to securely hold containers, making the device versatile and functional for fishing activities. The invention also comprises a method for using the device, outlining steps to anchor the frame, position the fishing rod, and securely place accessories, ensuring convenience and stability during use.

In this manner, the fishing rod-holding device of the present invention accomplishes all the foregoing objectives and provides a device for holding multiple fishing rods simultaneously, on land or boat. Further, the device can also secure a bait container. In addition, the device can further secure a drink.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a fishing rod-holding device. The device comprises a durable frame constructed from UV-resistant materials, suitable for outdoor use, and designed to provide a stable, free-standing structure for holding fishing rods. The frame includes at least one leg with a pointed end that facilitates ground insertion, anchoring the frame securely for hands-free operation. The legs can be configured as either fixed-length or telescopic, with the latter featuring adjustable height through locking mechanisms such as spring-loaded pins, twist-locks, or lever locks, allowing for height customization based on user needs and terrain conditions.

The frame further comprises at least one rod receiving area, typically a tubular structure designed to hold the handle of a fishing rod securely. This setup enables hands-free support, keeping the fishing rod in a stable, upright position. The rod receiving area is connected to the frame through a pivot point that allows for angling adjustments to optimize fishing position. The pivot point may incorporate various adjustment mechanisms, including locking ball-and-socket joints for multi-directional adjustments, locking hinged joints with preset stops for forward and backward tilt, swivel ratcheting joints for controlled rotational movement, or multi-position clamps with gear locks for precise angle selection. Each pivot configuration ensures stable positioning at the desired angle, accommodating different fishing techniques and environmental conditions.

Additionally, the frame or legs may include a receiving area for holding a cup or similar container, as well as a bait receiving area designed for a bait bucket or container. These receiving areas may be ring-shaped, cylindrical, or adjustable in diameter to hold containers of varying sizes.

Both the cup and bait receiving areas can include fasteners, such as hook-and-loop straps, elastic bands, or snap-fit clips, to securely hold items, with adjustability to accommodate containers of different shapes and dimensions.

The method of using the device involves anchoring the frame by inserting the pointed end of the leg into the ground, stabilizing the frame for hands-free support. The fishing rod handle is then placed into the rod receiving area, with the angle adjusted as needed via the pivot point. Additionally, objects like a cup or bait container may be placed in the corresponding receiving areas, with optional fastening for added security

Accordingly, the fishing rod-holding device of the present invention is particularly advantageous as it provides a device for holding multiple fishing rods simultaneously. Further, the device can also secure a bait container. In addition, the device can further secure a drink. In this manner, the fishing rod-holding device provides a solution to hold a plurality of fishing rods and other fishing-related supplies.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of one potential embodiment of a fishing rod-holding device of the present invention in accordance with the disclosed architecture;

FIG. 2 illustrates a rear perspective view of one potential embodiment of a fishing rod-holding device of the present invention in accordance with the disclosed architecture; and

FIG. 3 illustrates a flowchart of a method of using one potential embodiment of a fishing rod-holding device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device for holding multiple fishing rods. There also exists a long-felt need in the art for a fishing rod-holding device that can hold multiple fishing rods simultaneously. Further, there exists a long-felt need in the art for a fishing rod-holding device that can hold multiple fishing rods simultaneously wherein the device can also secure a bait container. In addition, there exists a long-felt need in the art for a fishing rod-holding device that can hold multiple fishing rods simultaneously wherein the device can also secure a drink.

The present invention, in one exemplary embodiment, is comprised of a fishing rod-holding device. The device includes a durable, UV-resistant frame designed for outdoor use and provides a stable, free-standing structure to hold fishing rods. The frame incorporates at least one leg with a pointed end for ground insertion, securing the frame for hands-free support. The legs may be either fixed-length or telescopic, with adjustable height enabled by locking mechanisms such as spring-loaded pins, twist-locks, or lever locks, allowing height customization to suit various user needs and terrain.

The frame also comprises at least one rod receiving area, typically a tubular structure designed to hold the handle of a fishing rod securely for hands-free use. The rod receiving area attaches to the frame through a pivot point, allowing angle adjustments to optimize the fishing position. The pivot point may utilize adjustment mechanisms, such as locking ball-and-socket joints for multi-directional adjustments, hinged joints with preset stops, swivel ratcheting joints, or multi-position clamps with gear locks. These configurations provide stable angling to accommodate diverse fishing techniques and conditions. The lower legs of the device may be detached and mounted on a boat for boat fishing.

Additionally, the frame or legs may include a receiving area for holding a cup and a bait receiving area for a container, both of which may be ring-shaped, cylindrical, or adjustable to hold containers of various sizes. Fasteners, such as hook-and-loop straps, elastic bands, or snap-fit clips, secure items within these areas and are adjustable to accommodate different shapes and dimensions.

The device's use involves anchoring the frame by inserting the leg into the ground for stability, then placing a fishing rod handle into the rod receiving area with angle adjustments made via the pivot point as needed. Further, the lower legs of the device may be detached and mounted on a boat for boat fishing. A cup or bait container may be placed in the designated areas with optional fastening for added security.

Overall, the fishing rod-holding device allows simultaneous support of multiple fishing rods and additional fishing supplies, providing a comprehensive solution for hands-free fishing needs.

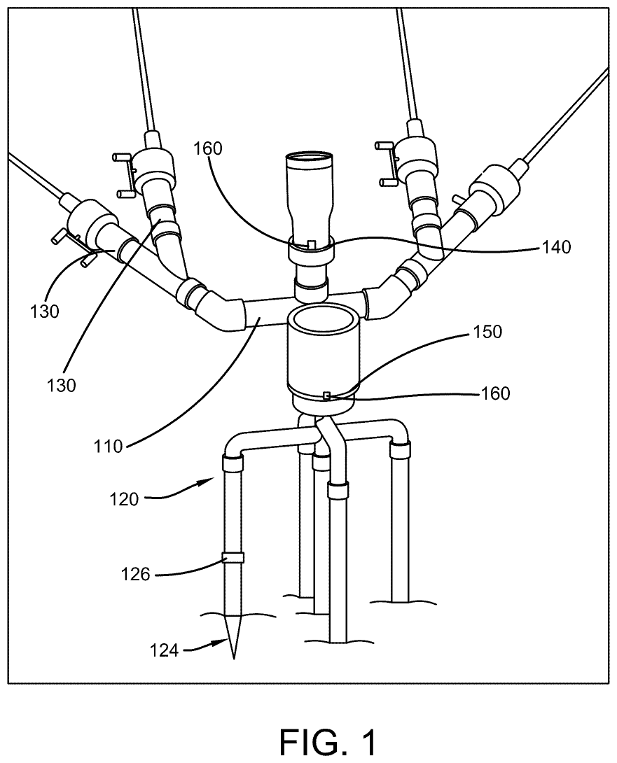

Referring initially to the drawings, FIG. 1 illustrates a front perspective view of one potential embodiment of a fishing rod-holding device 100 of the present invention in accordance with the disclosed architecture. The device 100 is comprised of a frame 110, which may be constructed from materials such as wood, metal, PVC, or combinations thereof, and may include UV-resistant materials to protect against sun damage and extend durability for outdoor use. When the legs 120 are inserted into a ground surface, the frame 110 remains free-standing, providing a stable and hands-free support structure suited for receiving fishing rods 10.

The frame 110 includes at least one leg 120. Each leg 120 may be designed as a straight or angled configuration, among other possible shapes, to enhance the stability of the frame 110 in a free-standing configuration. Preferably, the leg 120 has a pointed first end 122 (as seen in FIG. 1), facilitating its insertion into a ground surface, which anchors the frame 110 securely. The second end 124 of the leg 120 attaches to the frame 110 through fastening methods such as welding, bolting, or threading, depending on design and material requirements. In one embodiment, the leg 120 is of fixed length, while in an alternative embodiment, the leg 120 is telescopic, allowing adjustable frame 110 height configurations. The telescopic leg 120 includes at least one locking member 126 (as seen in FIG. 1), which may be a spring-loaded pin, twist-lock mechanism, or lever lock that holds the leg at a desired length, with multiple locking members 126 along the telescopic section to allow for incremental height adjustments.

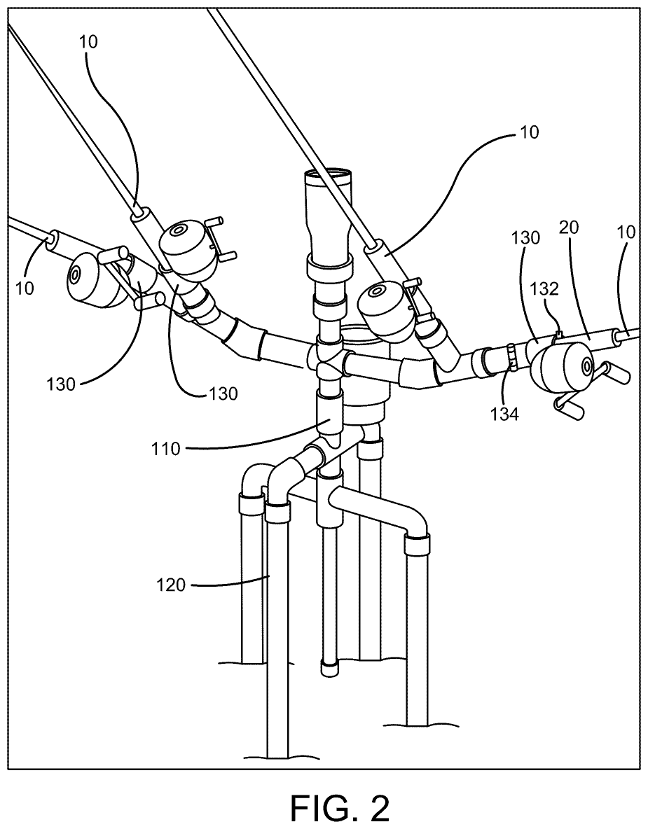

The frame 110 further comprises at least one rod receiving area 130. The area 130 is preferably a tubular structure designed to hold the handle 20 of a fishing rod 10. This arrangement enables hands-free support of the rod 10 and keeps the fishing rod 10 stable and secure, allowing the user to focus on other tasks while maintaining a fixed fishing position. In one embodiment, the rod receiving area 130 attaches to the frame 110 via at least one pivot point 134 (as seen in FIG. 2), which allows the fishing angle to be adjusted for optimal positioning based on user preference and environmental conditions. The pivot point 134 may comprise various mechanisms to facilitate this adjustable angling. In one configuration, the pivot point 134 may be a locking ball-and-socket joint, which permits multi-directional adjustment, allowing the rod receiving area 130 to be angled in any direction. Another possible configuration is a locking hinged joint that enables the rod receiving area 130 to tilt forward and backward within a single plane. Such a hinge may include preset stops or detents to lock the area 130 at specific angles, which can be particularly useful for certain fishing techniques. In an alternative embodiment, the pivot point 134 may include a swivel ratcheting joint that enables controlled rotational movement, allowing the rod receiving area 130 to be positioned along a circular path and securely held at the chosen angle. Finally, the pivot point 134 may be designed as a multi-position clamp or gear lock that allows the user to select from multiple fixed angles by rotating the rod receiving area 130 through gear teeth and locking it in place. Each of these pivot point 134 configurations permits the user to adjust the angle of the rod receiving area 130 to meet various fishing needs while ensuring stability once the desired angle is set.

Additionally, the leg 120 and/or frame 110 may include at least one receiving area 140 designed to hold a cup or similar container, as seen in FIG. 1 and FIG. 2. The receiving area 140 may be ring-shaped, cylindrical, or adjustable in diameter to accommodate various cup sizes. The leg 120 and/or frame 110 may further comprise at least one bait receiving area 150 (as seen in FIG. 1 and FIG. 2), providing a dedicated location for a bait container or bucket. Both the cup and bait receiving areas 140, 150 can be equipped with at least one fastener 160, such as a hook-and-loop strap, elastic band, or snap-fit clip, that secures items within the receiving areas. The fastener 160 may be adjustable to accommodate containers of differing shapes and sizes, ensuring a secure hold.

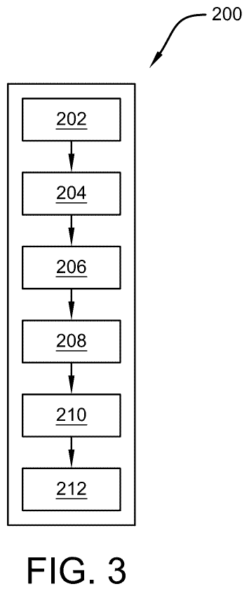

The present invention is also comprised of a method of using 200 the device 100, as seen in FIG. 3. First, a device 100 is provided, the device 100 comprising a frame 110 having at least one leg 120 and at least one rod receiving area 130 [Step 202]. Next, the pointed first end 122 of the leg 120 is inserted into a ground surface to anchor the frame 110 in a stable, free-standing configuration [Step 204]. Then, a fishing rod handle 20 is inserted into the rod receiving area 130, securing the fishing rod 10 in a hands-free, upright position [Step 206]. In one embodiment, the angle of the rod receiving area 130 is then adjusted by manipulating and locking the pivot point 134 to achieve a desired fishing rod angle [Step 208]. Additionally, an object can be placed into a cup receiving area 140 and/or a bait receiving area 150 [Step 210]. Optionally, the object can be secured in the receiving areas 140, 150 via at least one fastener 160 [Step 212].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “fishing rod-holding device” and “device” are interchangeable and refer to the fishing rod-holding device 100 of the present invention.

Notwithstanding the foregoing, the fishing rod-holding device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the fishing rod-holding device 100 as shown in the FIGS. are for illustrative purposes only, and that many other sizes and shapes of the fishing rod-holding device 100 are well within the scope of the present disclosure. Although the dimensions of the fishing rod-holding device 100 are important design parameters for user convenience, the fishing rod-holding device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A fishing rod-holding device comprising:
a frame comprised of a leg with a first end and a second end, the first end comprised of a pointed end and the second end attached to the frame; and
a rod receiving area configured to receive and support a fishing rod.

2. The fishing rod-holding device of claim 1, wherein the frame is comprised of a PVC material.

3. The fishing rod-holding device of claim 1, wherein the frame is comprised of a UV-resistant material.

4. The fishing rod-holding device of claim 1, wherein the leg is comprised of a telescopic leg.

5. The fishing rod-holding device of claim 4, wherein the leg is comprised of a locking member.

6. The fishing rod-holding device of claim 5, wherein the locking member is comprised of a spring-loaded pin.

7. The fishing rod-holding device of claim 5, wherein the locking member is comprised of a lever.

8. The fishing rod-holding device of claim 5, wherein the locking member is comprised of a twist lock.

9. The fishing rod-holding device of claim 1, wherein the rod receiving area is comprised of a tubular shape.

10. The fishing rod-holding device of claim 1, wherein the rod receiving area is comprised of a fastener.

11. A fishing rod-holding device comprising:
a frame comprised of:
a leg with a first end and a second end, the first end comprised of a pointed end and the second end attached to the frame;
a receiving area;
a rod receiving area configured to receive and support a fishing rod; and
a pivot point connecting the rod receiving area to the frame.

12. The fishing rod-holding device of claim 11, wherein the pivot point is comprised of a ball-and-socket joint.

13. The fishing rod-holding device of claim 11, wherein the pivot point is comprised of a hinge.

14. The fishing rod-holding device of claim 11, wherein the receiving area is comprised of a cylindrical shape.

15. A fishing rod-holding device comprising:
a frame comprised of:
a leg with a first end and a second end, the first end comprised of a pointed end and the second end attached to the frame;
a receiving area comprised of a fastener;
a rod receiving area configured to receive and support a fishing rod; and
a pivot point connecting the rod receiving area to the frame.

16. The fishing rod-holding device of claim 15, wherein the receiving area is comprised of a cylindrical shape.

17. The fishing rod-holding device of claim 15, wherein the fastener is comprised of a strap.

18. The fishing rod-holding device of claim 15, wherein the fastener is comprised of a band.

19. The fishing rod-holding device of claim 15, wherein the fastener is comprised of a clip.

20. The fishing rod-holding device of claim 15, wherein the frame is comprised of a metal.
